(19) United States
(12) Patent Application Publication
(10) Pub. No.: US 2006/0291381 A1
(43) Pub. Date: Dec. 28, 2006

(54) Diverse routing for switched connections

(75) Inventors: Michael Ellsworth Weedmark, Carp (CA); Peter Roberts, Stittsville (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: Alcatel, Paris (FR)

(21) Appl. No.: 11/158,996

(22) Filed: Jun. 22, 2005

(51) Int. Cl. H04J 3/14; H04L 12/56

(52) U.S. Cl. 370/228; 370/395.1

(57) ABSTRACT

A method and node is provided for setting up a diverse path of switched connections in a network. Results from a trace of a primary path are added to a setup signal for the diverse path. The results from the trace include connection identifications from the primary path, such as node and port identifications. In exemplary embodiments the trace is a connection trace or a path trace.

### FIELD OF THE INVENTION

This application relates to methods and apparatus for establishing diverse paths of switched connections across a network of nodes.

### BACKGROUND

Primary paths through PNNI (Private Network to Network Interface) networks may require backup connections. In order to reduce the risk of a backup connection failing, the backup connection should be routed over a diverse path.

For PVC (Permanent Virtual) connections, backup connections can be created with the involvement of a Network Management system (NMS) because the NMS has information on the path traversed by the main connection. The NMS can set up a primary and a backup path when commissioning an end to end connection. In this model, the NMS is the single point of processing.

For SPVC (Switched PVCs) connections, backup connections can be created with the involvement of a Network Management system (NMS) by configuring routing information that restricts which nodes/ports the main connection can use and which nodes/ports the backup connection can use. This, however, is very error prone, restrictive and operator intensive. In general, for switched connections (e.g. SPVCs (Switched PVCs) the NMS does not have any involvement in the routing decisions made when routing calls as connections are source routed, i.e. the source node of the connection determines its path.

RAPID (Reserved Alternate Path with Immediate Diversion) and ODR (Operator Directed Routing) are examples of methods that can be used by an NMS for setting up diverse connections for PVCs and SPVCs, respectively. RAPID switches to a reserved back-up path when there is a failure in the main connection. An alternative set of cross-connects are established for the back-up connection which do not use the same port and/or node as the main connection. The NMS sets up the primary and the back-up connections when commissioning the end to end connection. This is possible in PVC networks because the NMS knows every component and connection in the network. The NMS is in communication with each node on a management plane. RAPID is inadequate for switched connections due to lack of information about the traversed path, as previously mentioned.

In ODR, the NMS must commission each node that sources an SPVC with DTLs (Designated Transit Lists) that can be used when routing calls. Each SPVC that uses a backup connection would require information specifying which DTLs to use for the main connection and which DTLs to use for the backup connection. As previously mentioned, the configuration is error prone, restrictive and operator intensive.

For switched connections that do not use ODR in a PNNI network, the source node determines the entire path to be taken by a call. In a flat PNNI network, the source node has a view of all physical nodes in the network and can create a diverse route by analyzing the DTL used for the main connection. However, this diverse route may be more restrictive than required. For example, if only Node Identities and not Port Identities are specified in the DTL used by the main connection, then the backup connection must avoid entire nodes in order to ensure that it does not transit a port used by the main connection. In fact, since the source and terminating nodes cannot be avoided there can be no guarantee of a completely diverse path. If the Port Identities are specified in the DTL used by the main connection, a diverse route can be generated.

In a hierarchical PNNI network, portions of the network are identified only by LGNs (Logical Group Nodes). The source node can create a diverse path that avoids the LGNs used by the main connection but this could exclude potentially large collections of nodes. In addition, the last LGN can not be avoided as that LGN contains the termination point of the call. Accordingly, there is no guarantee of diversity in that LGN.

Another method of creating a diversely routed backup connection in hierarchical PNNI networks involves using policy based routing, such as that defined in af-cs-0195.000, which is incorporated herein by reference. This method of diverse routing requires that every link in the network has a unique identifier tag (Network Entity Network Service Category (Ne-NSC) in Policy routing nomenclature). In order to setup a diverse backup connection, the tags must be collected for the main connection. Furthermore, a policy constraint specifying a list of all links traversed by the main connection and a requirement to avoid those links must be included in a setup message for the backup connection. The main disadvantage of this method is the overhead of configuring unique tags on all network links. These tags must be distinguishable from other functional tags that exist in the system. Another disadvantage is that if the tags were not collected during call establishment, there is no way to create a diversely routed backup connection, i.e. NSC Report Lists that can be used to determine which links are traversed by a connection can only be returned during initial call establishment.

Without tagging every link in the network or tracing every call during call establishment, it is not currently possible for a source node to route a diverse connection in a PNNI hierarchical network.

In view of the foregoing, a means of efficiently establishing a diversely routed backup connection in a PNNI hierarchical network is required.

### SUMMARY OF THE INVENTION

Embodiments of the invention are directed to providing secondary paths of diversely routed switched connections, used as backup connections in, for example, a hierarchical ATM network. Currently, this can only be done using ODR or policy-based routing. The main disadvantage of ODR is the time required for an operator to manually configure the DTLs. The disadvantage with policy-based routing is that each link in the network must be uniquely tagged. Conversely, embodiments of the present invention require no extra configuration in the network.

Embodiments of the invention trace a connection either as it is being set up (using, for example, a Path Trace) or after it has been established (using, for example, Connection Trace) and include the resulting list of traversed nodes and/or ports in a connection setup message for a backup connection. An entry border node of each peer group that receives the setup message for a backup connection can establish a diverse route through its peer group by avoiding the nodes and/or ports specified in the list. Advantages of this method are that it requires no extra configuration in the network and can be applied to connections that have already been set up.

Accordingly, in one aspect of the invention, there is provided a method of establishing a secondary path of switched connections across a network of nodes, the method comprising: generating a setup signal for enabling the nodes to setup the secondary path, the setup signal containing one or more connection identifications obtained from a trace of a primary path.

In another aspect of the invention, there is provided a method of establishing a secondary path of switched connections through a network of nodes, the method comprising: receiving a signal to establish the secondary path through the network, the signal comprising one or more connection identifications obtained from a trace of the primary path; detecting the connection identification(s), and establishing the secondary path based on the connection identifications in the setup signal.

In another aspect of the invention, there is provided a network element configured to establish a secondary path of switched connections across a network of nodes, the network element comprising: a processing functionality configured to setup the secondary path based on a setup signal, the setup signal comprising one or more connection identifications obtained from a trace of a primary path.

In some embodiments, the network element is a node.

In a further aspect of the invention, there is provided a network element comprising means for requesting from one or more resources of a primary path in a communication network an identification of the resource, means for receiving each identification, and signal generating means for generating a setup signal for establishing a secondary path and for including in the setup signal one or more received identification(s).

In some embodiments said means for requesting is adapted to request an identification from a resource other than its nearest neighbour network element on the primary path.

In some embodiments said means for requesting comprises means for generating and transmitting at least one of a path trace and a connection trace on the primary path.

One embodiment of the invention includes an indicator in the setup message to indicate whether the backup path must be diverse at only the port level or at the node and port level.

Other aspects and features of the present invention will become apparent, to those ordinarily skilled in the art, upon review of the following description of the specific embodiments of the invention.

### BRIEF DESCRIPTION OF THE DRAWINGS

Embodiments of the invention will now be described in greater detail with reference to the accompanying drawings, in which:

FIG. 1 is a block diagram of a network in which embodiments of the present invention can be implemented;

FIG. 2 is a block diagram of a PNNI network in which embodiments of the present invention can be implemented;

FIG. 3 is a block diagram of a PNNI network in which embodiments of the present invention can be implemented;

FIG. 4 is a flowchart of a method according to an embodiment of the present invention;

FIG. 5 is a flowchart of a method according to an embodiment of the present invention;

FIG. 6 is a flowchart of a method according to an embodiment of the present invention;

FIG. 7 is a block diagram of a node according to an embodiment of the present invention;

FIG. 8 is a block diagram of a node according to an embodiment of the present invention;

FIG. 9 is a block diagram of a node according to an embodiment of the present invention;

FIG. 10 is a schematic diagram of a setup signal generated in accordance with an embodiment of the present invention; and

FIG. 11 is a block diagram of a network illustrating an embodiment of the present invention.

### DETAILED DESCRIPTION OF THE PREFERRED EMBODIMENTS

Embodiments of the present invention use a trace to determine the connection identifications of a primary path through a network. Examples of the trace include path trace and connection trace in a PNNI network. The results from the trace for the main connection are included in a setup message used to establish a diverse path. The trace results are used by nodes when determining the path for the backup connection in order to ensure its diversity from the primary path.

A path trace is presently used in switched networks to trace calls comprising switched connections. The setup message for the call includes a TTL IE (Trace Transit List Information Element). The TTL IE is used to record the Node Ids and Port Ids of the nodes and ports traversed by the connection being setup. This information is transported back to the source node in the Connect message.

A connection trace is used to trace a connected call. Presently, it is used by operators to determine the Node Ids and Port Ids of the nodes and ports that a specific call traverses. The operator selects an end point, which causes the launch of a Trace Connection Message. The Trace Connection Message traces the path through the network recording the Node Ids and Port Ids of the nodes and ports traversed by the connection being traced. A Trace Connection Acknowledge Message including the recorded information is generated by the terminating node and sent back to the originating node.

Details of path and connection traces may be found in The ATM Forum Technical Committee Publication af-cs-0141.002 entitled PNNI Addendum for Path and Connection Trace Version 1.1. (PACT 1.1) dated February 2004, which is incorporated herein by reference.

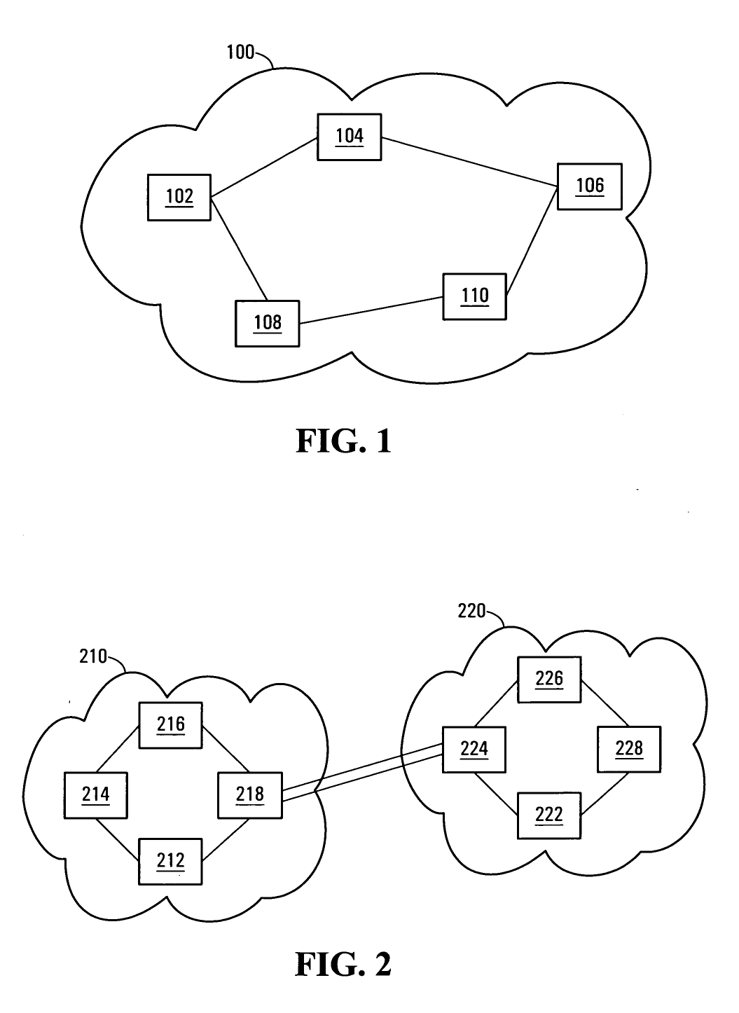

FIG. 1 is a block diagram of a network 100 in which an embodiment of the present invention may be implemented. The network comprises nodes and communication paths connecting the nodes. Nodes 102, 104, 106, 108 and 110 make up the network. Node 102 interfaces with nodes 104 and 108. Node 104 interfaces with nodes 102 and 106. Node 106 interfaces with nodes 104 and 110. Node 108 interfaces with nodes 102 and 110. Node 110 interfaces with nodes 108 and 106. Although the network 100 of FIG. 1 has five nodes with each node interfacing with two other nodes, the invention may be implemented in a network of any number of nodes and each node may interface with any number of other nodes. Examples of networks in which embodiments of the invention may be implemented are PNNI networks, flat and hierarchical. The nodes in the network can be any switched connection node such as ATM switches. Any of the nodes 102, 104, 106, 108, 110 can be configured to set up a diverse path of switched connections in accordance with embodiments of the present invention. Examples of node configuration and methods of setting up secondary paths are described below.

FIG. 2 is a block diagram of a PNNI network in which embodiments of the present invention may be implemented. The network has two LGNs 210 and 220. LGN 210 has four nodes 212, 214, 216 and 218 in a ring formation. LGN 220 has four nodes 222, 224, 226 and 228 in a ring formation. Nodes 218 and 224 are border nodes and interface with each other, thereby providing a link between the two LGNs. It is understood that the network described with reference to FIG. 2 is an example only and that any PNNI network having any number of LGNs can use the present invention. Furthermore, each LGN may have any number of nodes, including other LGNs. Any of nodes 212, 214, 216, 218, 222, 224, 226 and 228 is configured in a manner discussed below to set up a secondary path of switched connections.

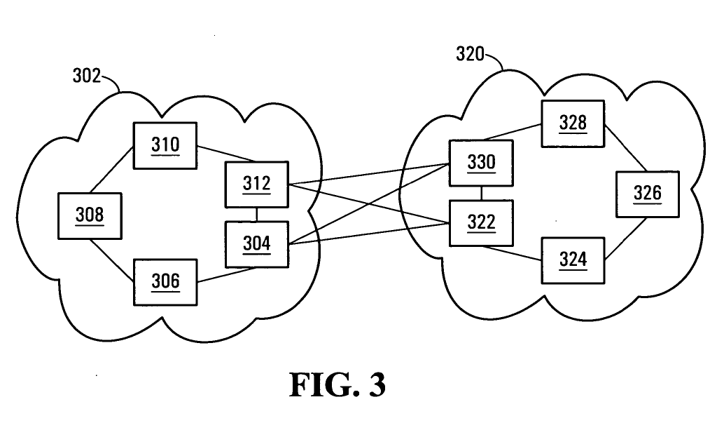

FIG. 3 is a block diagram of a PNNI network having two LGNs 302 and 320. LGN 302 has five nodes 304, 306, 308, 310 and 312 in a ring formation. LGN 320 has five nodes 322, 324, 326, 328 and 330 in a ring formation. Nodes 312, 304, 322 and 330 are border nodes and are all in communication with each other. Node 312 is an alternate border node for node 304 and node 322 is an alternate border node for node 330. Therefore, if node 330 is on a primary path, node 322 can be used for a diverse back-up path. Any of nodes 304, 306, 308, 310, 312, 322, 324, 326, 328 and 330 is configured to set up a secondary path of switched connections as described below.

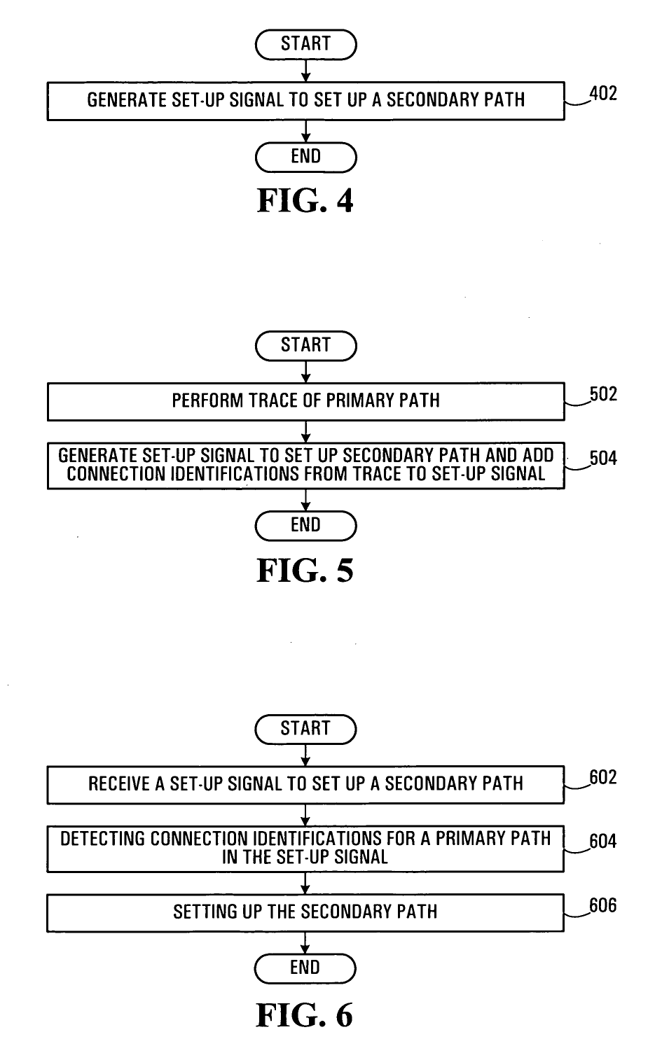

Embodiments of the present invention include methods and nodes for setting up secondary paths of switched connections through a network. FIGS. 4 to 6 are flowcharts of examples of methods in accordance with embodiments of the invention.

FIG. 4 is a flowchart of a method according to an embodiment of the present invention. At Step 402 a setup signal is generated to set up a secondary path through a network such as the networks described above with reference to FIGS. 1, 2 and 3. The setup signal includes connection identifications of the primary path, the connection identifications having been obtained by way of a trace. Examples of traces that could be used are path trace and connection trace, as described above.

By way of example, in the network 100 referred to with reference to FIG. 1, if a primary path exists from node 102 to node 104 to node 106, to set up a secondary path, node 102 generates the setup signal. In some embodiments, the node at the start of a path is called the source node. The setup signal will include all of the connection identifications, such as port and node identifications, from the primary path. The connection identifications would have been obtained by way of a trace initiated by node 102, either when the primary path was set up or later. Nodes that receive the setup signal will attempt to avoid the connection identifications included in the setup signal when setting up the diverse path.

In another example, referring to FIG. 2, if the primary path is from node 214 to node 216 to node 218 to node 224 to node 226 to node 228, the setup signal for the secondary path is generated by node 214, which is the source node in this scenario. The setup signal will include the node and port identifications for the primary path. Preferably, the secondary path will avoid the node and port identifications in the setup signal. In the network of FIG. 2, nodes 218 and 224 are border nodes and can not be avoided. Therefore, the secondary path will use different ports on these nodes from the ports used on the primary path, if possible.

In some embodiments, more than one border node is available at an LGN. In those cases, if a border node receives a setup signal for a secondary path that includes its own node identification as part of the primary path, it is adapted to crank-back the setup signal to the exit border node of the previous LGN. The border node of the previous LGN will then crankback the setup signal to the source node or the entry border node of its LGN to select an alternate exit border node for its LGN. The network described with reference to FIG. 3 is an example of a network where more than one border node exists in an LGN.

FIG. 5 is a flowchart of a method according to an embodiment of the invention. At Step 502 a trace of a primary path comprising switch connections through a network is performed. In some embodiments, the trace is performed by a source node. Examples of traces that can be performed are path trace and connection trace. If a connection trace is performed it can be done after the primary path is established. A path trace is done while setting up the primary path. The results of the trace are the connection identifications of the primary path, which may include node identifications and/or port identifications of each connection in the primary path. A setup signal for a secondary path is generated at Step 504 in a manner similar to that described with reference to Step 402 of FIG. 4. Generating the setup signal comprises adding the connection identifications obtained from the trace to the setup signal and building a DTL that avoids nodes and or ports traversed by the primary path. Note that in a hierarchical network, entry board nodes share this responsibility.

FIG. 6 is a flowchart of a method according to an embodiment of the present invention. At Step 602 a setup signal to set up a secondary path is received. The setup signal includes connection identifications of a primary path which were obtained by a trace, such as those described above. At Step 604, the connection identifications are detected in the setup signal. In some embodiments, the setup signal includes an IE indicating that the connection identifications and their values are included. Next, at Step 606, a secondary path is determined based on the setup signal. In some embodiments, this involves avoiding connections matching the connection identifications in the setup signal. If it is impossible to avoid a particular connection, an error occurs. The handling of errors can be performed according to a predetermined policy. For example, in some embodiments, an error message is sent back to the source node and the NMS may be notified.

The above described methods are implemented by nodes configured in accordance with embodiments of the present invention.

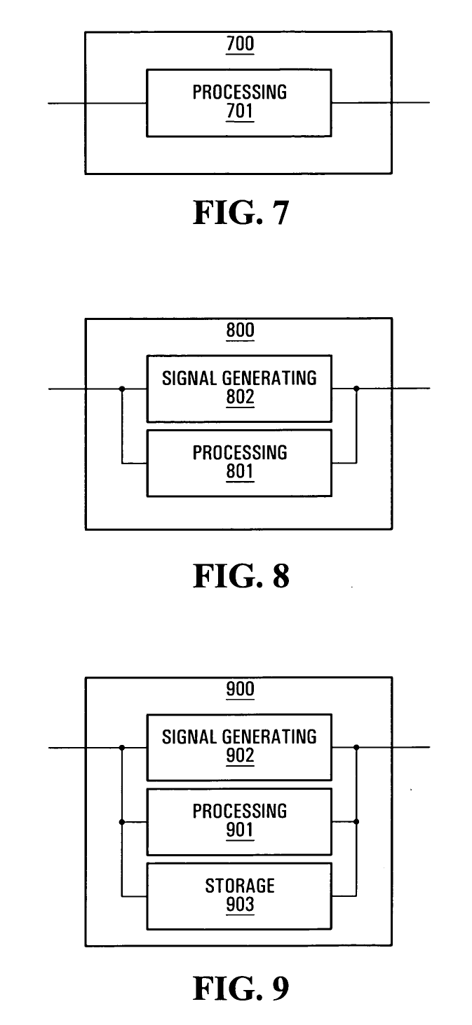

FIGS. 7 to 9 are block diagrams of examples of nodes configured in accordance with embodiments of the invention.

FIG. 7 is a block diagram of a node 700 according to an embodiment of the present invention. Node 700 comprises a processing functionality 701. The processing functionality processes incoming setup messages for a secondary path. The processing functionality detects the connection identities of the primary path in the setup message and determines a secondary path based on those connection identities, along with normal path selection parameters. Preferably, the processing functionality selects a secondary path avoiding the connection identities of the primary path, if possible. In some embodiments node 700 is a border node. The processing functionality can be implemented using hardware, software or any combination thereof.

FIG. 8 is a block diagram of a node 800 according to an embodiment of the present invention. Node 800 comprises a processing functionality 801 and a signal generating functionality 802. The processing functionality 801 performs functions similar to processing functionality 701 described with reference to FIG. 7. The signal generating functionality 802 generates setup signals for a secondary path. The setup signals include connection identifications from a primary path that were obtained by way of a trace. In some embodiments the signal generating functionality is also configured to send out trace signals for tracing primary paths. The signal generating functionality may be implemented using hardware, software or any combination thereof. In some embodiments, node 800 is a source node. In other embodiments, node 800 is a border node.

FIG. 9 is a block diagram of a node 900 according to an embodiment of the present invention. Node 900 comprises a processing functionality 901, a signal generating functionality 902 and a storage means 903. The processing functionality is configured to perform functions similar to the processing functionalities 701 and 801 described with reference to FIGS. 7 and 8. The signal generating functionality 902 is configured to perform functions similar to those of the signal generating functionality 802 described with reference to FIG. 8. The storage means 903 is used to store connection identifications obtained from a trace of a primary path. In some embodiments the connection identifications are stored temporarily until a secondary path is established. In other embodiments, the connection identifications are stored for a longer period of time. The storage means can comprise hardware, software or any combination thereof. In some embodiments, node 900 is a source node. In other embodiments, node 900 is a border node.

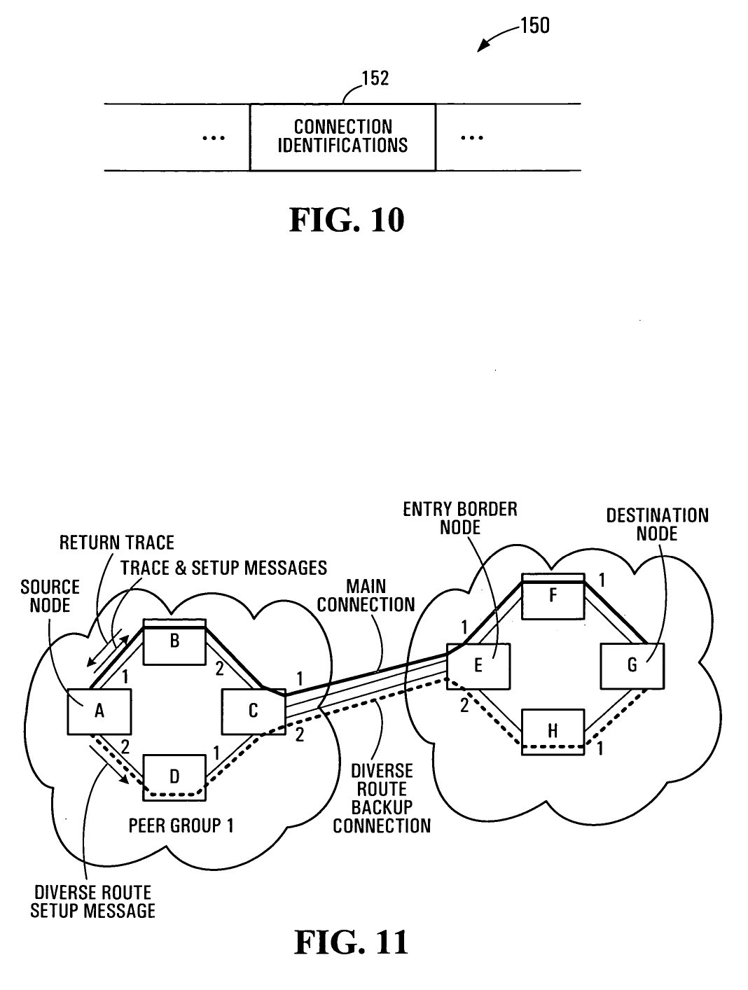

A setup signal 150 for a secondary path, generated in accordance with an embodiment of the present invention, will now be described with reference to FIG. 10. As discussed above, the setup signal 150 indicates to the nodes to setup a secondary path and contains the connection identifications 152 of a primary path. The setup signal could be a setup message with a special IE containing the connection identifications to be avoided.

FIG. 11 is a block diagram illustrating an example of diverse routing on a switched connection according to an embodiment of the invention. The network of the example comprises two peer groups (Peer Group 1 and Peer Group 2). Peer Group 1 comprises four nodes A, B, C and D arranged in a ring formation. Peer Group 2 comprises four nodes E, F, G and H also arranged in a ring formation. Nodes C and E are border nodes and are in communication with each other.

In the example of FIG. 11, Node A, which is the source node, sends a setup message to create a switched connection (main connection) to Node G, the destination node. Included in the setup message is the request to collect a path trace of the connection as it is established. The trace returned to Node A lists all of the nodes and ports traversed by the main connection. In this particular example, this list would be A.1, B.2, C.1, E.1, F.1. The source node then sends a setup message to create a diversely routed backup connection. This setup message includes the list of nodes and ports traversed by the main connection as resources to be excluded by the backup connection. The source node (Node A) determines a diverse route for the backup connection in its peer group, Peer Group 1, while the entry border node (Node E) in Peer Group 2 determines a diverse route for the backup connection in its peer group in accordance with the list of traversed nodes and ports. In this particular example the diverse path would include the connections A.2, D.1, C.2, E.2, and H.1.

What has been described is merely illustrative of the application of the principles of the invention. Other arrangements and methods can be implemented by those skilled in the art without departing from the spirit and scope of the present invention.

1. A method of establishing a secondary path of switched connections across a network of nodes, the method comprising:
generating a setup signal for enabling the nodes to setup the secondary path, the setup signal containing one or more connection identifications obtained from a trace of a primary path.

2. The method of claim 1 further comprising:
sending a trace signal requesting the connection identifications of the primary path; and
including at least one connection identification received in response to the trace signal in the setup signal.

3. The method of claim 2, wherein the trace signal is at least one of a path trace signal and a connection trace signal.

4. The method of claim 1, wherein the primary path traverses at least one LGN (Logical Group Node) and the secondary path traverses at least one LGN of the primary path.

5. The method of claim 1, wherein each connection identification comprises at least one of a node identification and a port identification.

6. The method of claim 1, wherein the network is an ATM (Asynchronous Transfer Mode) network.

7. The method of claim 6, wherein the ATM network is a PNNI (Private Network-Network Interface) network.

8. The method of claim 1, wherein the network is a hierarchical network.

9. The method of claim 7, wherein the PNNI network is a hierarchical network.

10. A method of establishing a secondary path of switched connections through a network of nodes, the method comprising:
receiving a signal to establish the secondary path through the network, the signal comprising one or more connection identifications obtained from a trace of the primary path;
detecting the connection identification(s), and
establishing the secondary path based on the connection identifications in the setup signal.

11. The method of claim 10, further comprising if the setup signal is received at a border node whose connection identification is contained therein, transmitting a signal from the border node to the node from which the signal was received indicating that the border node is on the primary path.

12. The method of claim 11, further comprising the node from which the signal was received determining if the secondary path can be routed to another border node.

13. A network element configured to establish a secondary path of switched connections across a network of nodes, the network element comprising:
a processing functionality configured to setup the secondary path based on a setup signal, the setup signal comprising one or more connection identifications obtained from a trace of a primary path.

14. The network element of claim 13, further comprising a signal generation functionality configured to create the setup signal.

15. The network element of claim 13, further configured to initiate the trace.

16. The network element of claim 13, further comprising a storage means for storing a list of the connection identifications.

17. The network element of claim 15, wherein the trace is at least one of a path trace and a connection trace.

18. A machine readable medium having computer readable instructions stored thereon for execution by a network element that when executed implement the method of claim 1.

19. A machine readable medium having computer readable instructions stored thereon for execution by a network element that when executed implement the method of claim 2.

20. A machine readable medium having computer readable instructions stored thereon for execution by a network element that when executed implement the method of claim 10.
